(19) United States
(12) Patent Application Publication
(10) Pub. No.: US 2026/0192669 A1
(43) Pub. Date: Jul. 9, 2026

(54) NOTIFICATION MANAGEMENT METHOD FOR A VEHICLE-BASED MAN-MACHINE INTERFACE, AND VEHICLE HAVING A NOTIFICATION MANAGEMENT SYSTEM

(71) Applicant: MERCEDES-BENZ GROUP AG, Stuttgart (DE)

(72) Inventor: Theodor Minh-Thien NGUYEN, Holzgerlingen (DE)

(21) Appl. No.: 19/115,332

(22) PCT Filed: Sep. 15, 2023
(86) PCT No.: PCT/EP2023/075537

§ 371 Date: Mar. 26, 2025

(30) Foreign Application Priority Data
Sep. 27, 2022 (DE) 10 2022 003 536.7

(51) Int. Cl. B60K 35/29; B60K 35/28

(52) U.S. Cl. CPC B60K 35/29; B60K 35/28; B60K 2360/186

(57) ABSTRACT

A notification management system for a vehicle-based man-machine interface forwards or withholds a notification, directed to at least one vehicle occupant and/or a vehicle functional module, to a notification channel based on a priority linked to the notification. The priority linked to the notification priority linked is set by a priority number. The notification is selected and forwarded to the notification channel if the priority number thereof exceeds a channel threshold assigned to the notification channel and if the notification has the highest priority number for the respective notification channel. The channel threshold can vary over time and is set, in a normal operating mode, between a minimum threshold and a maximum threshold by the notification management system in a specified time interval based on various data.

### BACKGROUND AND SUMMARY OF THE INVENTION

Exemplary embodiments of the invention relate to a notification management method for a vehicle-based man-machine interface and to a vehicle having a notification management system.

The development of assistance systems is accompanied by increased demands on information management for infotainment systems in vehicles, which are increasingly being transformed into a complex man-machine interface. To this end, a multitude of interaction channels are provided for information transmission and to influence a driver. One conventional interaction channel for displaying visual information is a graphical user interface (GUI), which is typically designed as a touch-sensitive display in the vehicle console. As well as large-format liquid crystal displays, projection systems that generate images on the vehicle interior surfaces are increasingly being provided for this purpose. Smart glasses worn by the driver and wirelessly communicating with the infotainment system also offer a possible visual interaction channel. The use of acoustic interaction channels is also noteworthy, for example via a voice assistant, by means of an audible warning or by a recognizable message melody.

Furthermore, the man-machine interface can also use tactile signals and other ways of influencing a driver to transmit information. Also possible are subliminal measures for boosting attention and improving the journey comfort in general. For example, a directed air stream or a heat, cold or olfactory stimulus can be used as an alternative interaction channel. A seat massage device also constitutes a possible interaction channel of a vehicle-based man-machine interface for the transmission of notifications.

In addition to the transmission of vehicle-relevant and surroundings-relevant data, it is also often desired to receive notifications for entertainment purposes and to stay in constant contact with the outside world during the journey. Therefore, possible notifications by the man-machine interface also include the playing back of media content, for example films or music videos, or audio content, such as audio books, pieces of music, podcasts, and the like. In addition, it should also be possible for the man-machine interface to initiate playing social media content or podcasts, or for data generated by a chat program or a video conference program to be output. Not only does the man-machine interface deal with notifications for the driver, but also those primarily intended for other vehicle occupants.

Due to the increase in information density and the enhanced possibilities for interaction, there is a need to make a selection from the abundance of possible notifications that are not directly requested by the driver but rather originate from the man-machine interface, referred to herein as proactive notifications, and to decide at what time and using which of the available interaction channels the driver or the vehicle occupants are intended to be addressed by means of such a notification. The notification sequence must not be distracting, fatiguing or overwhelming, in particular for the driver. In addition, the steady flow of proactive notifications and the selected type of transmission must not lead to a feeling of boredom or that the man-machine interface is taking over control. The driver in particular must be able to consciously perceive relevant information in the notification sequence and this should be transmitted in a timely manner. These challenges are imposed on a method and a system used therefor for notification management.

Methods for prioritizing messages are known from other technical fields. For example, US 2021/0337039 A1 describes a prioritization system for messages generated by a plurality of apps on an electronic device. This document deals with a rule-based selection of app notifications for forwarding to an individual user interface, in this case a single display, based on a priority allocated to the respective app during the installation process, with the typically use case being for a computer system on which a plurality of notification-generating software programs, such as an e-mail program or games, run. The prioritization system ensures that a predetermined number of app notifications forwarded to the system user is not exceeded within a specified time period, where in the event that multiple notifications arrive at the same time, only information originating from the app with the highest priority is selected for the display. The use of such a rule-based concept with initially configured priorities for a man-machine interface of a vehicle results, in particular because of the plurality of vehicle-side interaction channels, in a complex system that is very difficult to manage in terms of its configuration.

A further message prioritization method is known from EP 1 287 444 B1, the primary application of which is the handling e-mails. It is proposed to give messages a classifier that defines the urgency and/or relevance in particular of an e-mail. The messages fed to a user are then selected in rule-based manner by requesting the classifier and based on a profile that is at least initially configured by the recipient. Typically, different profiles are created for the user that depend on the whereabouts and the respective activity; for example, different profiles can be provided for work, leisure, holidays, travel, etc. In the case of an activity outside of the workplace or home, e-mails selected in an automated manner by the message prioritization system are sent to a designated mobile device of the user instead of their desktop. Alternating between profiles is effected by a user input or by user entries, for instance in a personal electronic calendar, being queried.

When used in a vehicle-based man-machine interface, the message prioritization method proposed by EP 1 287 444 B1 results in an application that must be laboriously configured by the respective user before starting driving. Even individually defining the prioritization rules for using the basic functionality of a complex vehicle-installed man-machine interface requires a considerable degree of effort on the part of the user before starting driving. Activating the full range of functions requires more in-depth familiarization with rule-based profile setting and this cannot be performed without expert knowledge of the respective vehicle-based man-machine interface.

U.S. Pat. No. 9,769,106 B2 discloses a method for a mobile end device for rule-based display and prioritization of visual messages based on an adapted tile design on the display of the mobile end device. This involves the use of a predefined system of rules for dividing messages into categories, which are then displayed category—specifically on different areas of the display. Messages in the same category are shown in order of their priority. To define the prioritization within a message category, user behavior is analyzed. The message source and the average time duration taken by the user of the mobile end device to react to a message from the respective message source are determined. Using the described message prioritization method for a vehicle-based man-machine interface leads to the fundamental difficulty that, when used in vehicle, there is a huge range of message types that usually cannot be classified uniformly. A further difficulty arises from the complexity of the man-machine interface of vehicle with a plurality of interaction channels. Moreover, the analysis of the user behavior needed for the prioritization, in particular how long they take to react to messages from a known message source, is not feasible for a plurality of proactive notifications lined by the vehicle.

Exemplary embodiments of the present invention are directed to an improved notification management method for a vehicle-based man-machine interface, using which notifications are transmitted to the driver in particular in such a way that, in terms of time and with respect to the selected notification channel, the driver's level of attention is not impaired and they are not disrupted thereby. In particular, the intention is for the user to be able to execute the notification management method for proactive notifications in the case of a plurality of possible notification channels without having to perform a complicated system configuration. Furthermore, a vehicle with a notification management system improved in such a way is to be specified.

A generic notification management method for a vehicle-based man-machine interface comprising at least one notification channel forwards, by means of a notification management system, a notification, directed to at least one vehicle occupant and/or a vehicle functional module, to the notification channel or withholds the respective notification on the basis of a priority linked to the notification.

The notification management method according to the invention is characterized in that
the priority linked to the notification is set by a priority number;
the notification is selected and forwarded to the notification channel if the priority number thereof exceeds a channel threshold assigned to the notification channel and if said notification has the highest priority number for the respective notification channel; and
the channel threshold can vary over time and is set, in a normal operating mode, between a minimum threshold and a maximum threshold by the notification management system in specified time intervals on the basis of driving data and/or vehicle surroundings data and/or vehicle data and/or state data of the man-machine interface and/or at least one previous notification transmission and/or vehicle occupant observation data.

The notification itself can be purely communicative in nature, but can also include activation signals which, in addition to activating information elements, such as a display, can also activate functions in a functional module of the vehicle, e.g., a massage device in a vehicle seat. This notification/activation of the functional module can be effected both together with or including a communicative notification—e.g., as haptic feedback—or without this.

According to the invention, instead of a rigid system of rules for the prioritization, every notification is linked to a typically decimal priority number that can be understood as a resource in the sense of a currency using which the forwarding to a notification channel can be “purchased”. According to this concept of the inventive idea, a market value, the respective channel threshold, is defined for the notification forwarding, which is subject to a change over time within specified limits between a minimum threshold and a maximum threshold. A notification can ensure that it is fed to a notification channel, i.e., it becomes active and can be perceived by the user via the selected notification channel, if its priority number exceeds at least the required threshold value and if at the same time it is currently the “highest bidder” in the case of a plurality of notifications that meet the threshold condition. The special case of matching priority numbers can be resolved by requesting a further comparison criterion, for example the time spent in the waiting loop, which can be used as a special bonus for determining a final priority number.

The threshold definition is to be updated in a specified time interval. Typical rates of change of state for vehicles, such as a car, lorry, van, bus, or the like, and the data processing speeds that typically exist are used as a basis for this. It is practical to specify a time interval in the millisecond range.

To define a threshold value for a notification channel, at least one of the aforementioned criteria is used, where a first group relates to driving data, vehicle surroundings data, and vehicle data. For one exemplary embodiment, the current driving speed is taken into account for the “driving data” criterion, with provision being made, in particular for high driving speeds, to suppress notifications that may potentially disrupt the driver's concentration, so that the threshold is generally raised.

For a further exemplary embodiment, vehicle surroundings data is relevant, in which case it can be queried whether the journey is taking place in confusing traffic or in the region of a motorway construction site with a reduced lane width, meaning that a certain level of attention is demanded of the driver and the channel thresholds have to be set to high. Further criteria relating to vehicle surroundings arise for a journey at night or in poor weather conditions. In the present case, the temporal embedding of events also falls under the term “vehicle surroundings data”. Accordingly, the day of the week or the calendar month during which a journey takes place are also understood as vehicle surroundings data.

For an alternative embodiment, for the threshold value generation, account is taken of data that can be assigned the criterion “vehicle data”. This includes, for example, the setup of the man-machine interface, whereby in the case of a high number of available notification channels that are usually perceived by the driver as disruptive if they are used too frequently, the number of notifications that get through to the vehicle occupants is reduced when the channel thresholds are set to high.

For a further advantageous embodiment of the channel threshold setting, the current state data of the man-machine interface is taken into account. If, for example, an acoustic notification channel is active due to an entertaining audio file, for example a podcast, being played back, the assigned channel threshold is increased such that a voice message is only played if this is considered to be particularly relevant and is provided with a priority number above the raised threshold.

An embodiment that takes account of at least one of the previous notification transmissions is advantageous. This can prevent notifications from being chronologically too close together, for example. Furthermore, the nature and duration of at least one previously active notification can be a criterion for setting the threshold.

For one preferred embodiment, vehicle occupant observation data is relevant for determining the channel threshold. This can be, for example, the reaction to a notification that has become active, for instance a proactive notification, which relates to a traffic jam up ahead. If the driver then asks, for example via a voice assistant, for alternative routes, the channel threshold for a notification channel provided for transmitting social media content is significantly increased in order to suppress disruptions. The vehicle occupant observation data can also be used for determining the number of people in a vehicle in order to generally increase the channel thresholds if there are multiple occupants.

In addition, vehicle occupant observation data can be recorded over a relatively long time period with a person-specific assignment. For example, if a driver usually activates the seat heating beyond a certain temperature or if the seat massage device is often switched on after a certain driving duration, then the threshold for a notification channel linked to these comfort devices can be lowered in a manner tailored to the respective person, so that a proactive notification, i.e., an activation not performed by the user themselves, can be effected more easily.

For one possible embodiment, the priority number assigned to a notification is static. For one advantageous design development, the priority number of a notification is also a dynamic variable, at least until transmission to the notification channel. It is preferred in this case that the temporally variable adjustment of the priority number is performed, in normal operating mode, by the notification management system in specified time intervals, in turn on the basis of driving data and/or vehicle surroundings data and/or vehicle data and/or at least one previous notification transmission by the man-machine interface and/or vehicle occupant observation data and/or the time spent by a notification in a waiting loop of the notification channel and/or the duration of an activation state of a notification in the notification channel, in such a way that the priority number is set between a priority minimum above the minimum thresholds and a priority maximum below the maximum threshold of a notification channel.

For advantageous exemplary embodiments, at high driving speeds, the priority number of a notification informing that the state of charge of a traction battery of an electric vehicle has significantly fallen can be increased over time. A further increase can be effected if the vehicle occupant observation data reveal that the driver is not taking adequate measures to head for a charging point. For a further preferred embodiment, the priority number of a warning message rises if the vehicle surroundings data detects visual irregularities on the road surface at temperatures in the region of freezing point. For further embodiments, the nature of a previous notification transmission can be taken into account. If, for example, a push message about sports news was transmitted to the vehicle occupants, the priority number for further sports-related social media content can be lowered in order to reduce the probability of potentially boring, repetitive content being transmitted to the vehicle occupants.

For a further design configuration, provision is made to request the priority number of a notification even after it has been forwarded to a notification channel and to preferably adapt it dynamically. Preferably, a forwarded notification remains active on a notification channel until the priority number of the notification falls back below the assigned channel threshold. By way of example, a text message currently being shown on a vehicle display can have a degressive priority number, so that it disappears after a certain time for a constant channel threshold. In addition, the channel threshold may change, for example because of a driving situation which demands the driver's full attention and causes the channel threshold to rise. Thus, visual stimuli which might possibly impair concentration disappear from the display.

Proactive notifications are perceived as being particularly disruptive when they lead to a constant stream of information. For one preferred embodiment, after forwarding a notification to a notification channel, the notification management system raises the assigned channel threshold in the next time interval. Preferably, further messages are completely suppressed for a predetermined time by setting, for a selected time duration, the assigned channel threshold to the maximum threshold that cannot be exceeded by any possible priority number. An embodiment in which there is a “cooling down phase” after a notification channel has been activated is particularly advantageous, wherein, for this purpose, a degression of the assigned, initially raised channel threshold occurs within a specified time span after a notification has been forwarded.

For a typical man-machine interface of a vehicle there are a plurality of notification channels. For one preferred design development, the notification management method according to the invention leads to a high success rate for the selection of the notification channel suitable for the respective notification. Preferably, a separate channel threshold that can vary over time is defined for such a man-machine interface for each individual notification channel. Furthermore, a notification that is provided for at least two notification channels simultaneously is assigned a dedicated priority number for the respective notification channel. Particularly advantageous is a design for which a change to the channel threshold of a first notification channel also causes the channel threshold of at least one second notification channel to change. By way of example, there may be a first audio message that prompts the driver to take a break on a first notification channel for a primary voice output and additionally on a second notification channel for a secondary voice output in the respective waiting loops, where a secondary voice output relates to adding additional information to a primary voice output. In the two notification channels, the priority numbers of the first audio message should initially be below the respective channel thresholds, meaning that this message is held back. If a relevant second audio message then arrives for the first notification channel, this message indicating, for example, a critically low state of charge of the traction battery and the priority number of which is above the assigned channel threshold, the primary voice output is activated and consequently the channel threshold for the secondary voice output is lowered, so that the notification that was originally waiting with the take-a-break request also has a priority number above the channel threshold and is immediately added as a secondary voice message. Thus, the driver is first of all asked, because of a low battery state of charge, to head for a charging point and they are then also advised to take a break for driving safety reasons.

For an additional development of the invention, based on driving data, vehicle surroundings data, vehicle data, vehicle occupant observation data, and/or a vehicle-external notification, a switch can be made from a normal operating mode to a rule-based mode for at least one notification channel of the man-machine interface. In this case, the notification management system sets the channel threshold to the minimum threshold or the maximum threshold for at least one notification channel selected for the rule-based mode. If the maximum threshold is selected, the affected notification channel is completely blocked. Conversely, setting the minimum threshold causes every notification provided for the affected notification channel to become active.

For one development, a vehicle according to the invention has a notification management system for a man-machine interface, which is designed such that the notification management method according to the invention can be executed.

### BRIEF DESCRIPTION OF THE DRAWING FIGURES

Further advantageous embodiments of the notification management method will become apparent from the exemplary embodiments, which are described in more detail hereinafter with reference to the figures, in which:

FIG. 1 shows the temporal course of a first exemplary embodiment of the notification management method according to the invention;

FIG. 2 shows the temporal course of a second exemplary embodiment of the notification management method according to the invention; and

FIG. 3 shows schematically simplified the notification channel of the second exemplary embodiment according to FIG. 2.

### DETAILED DESCRIPTION

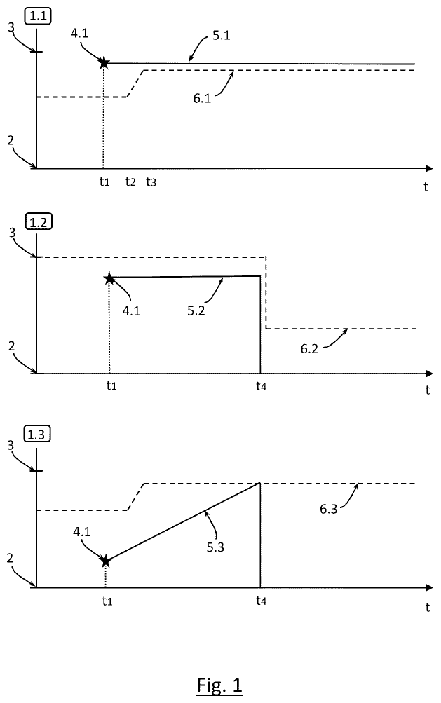

FIG. 1 shows a first exemplary embodiment of the notification management method according to the invention with reference to simplified temporal charts. At time t1, the occurrence of a proactive notification 4.1, which was generated by a control device of an electric vehicle because of a critically low state of charge of a traction battery, can be seen in the waiting loops of the schematically symbolized notification channels 1.1, 1.2 and 1.3. In this case, the notification channel 1.1 represents a message channel on a display that forms a part of a man-machine interface (not shown in detail).

The further notification channels 1.2 and 1.3 are audio channels, which are assigned to a voice assistant. Here, the notification channel 1.3 is designed for a primary voice output without a further condition, while the notification channel 1.2 is provided for a secondary voice output which only takes place when this can be added to an immediately preceding primary voice output. Accordingly, the notification channel 1.2 is shifted to a rule-based mode at time t1, at which this additional condition is not met, and is blocked for output, wherein the channel threshold 6.2 relevant for the notification forwarding assumes maximum threshold 3. For the notification channel 1.1 which is in the normal operating mode, the channel threshold 6.1 lies between the minimum threshold 2 and the maximum threshold 3.

In the waiting loop of the notification channel 1.1, the notification 4.1 is assigned a static priority number 5.1, which at time t1 is above the channel threshold 6.1 required for the forwarding to the notification channel 1.1. Consequently, a direct notification output results, with a database being accessed to generate a text message corresponding to the notification 4.1.

For the notification channel 1.3, the notification 4.1 provides a priority number 5.3 at time t1 that is below the assigned channel threshold 6.3. Therefore, at first, no primary voice message is output. The priority number 5.3 is dynamically created and increases over time, i.e., with increasing duration of the critically low state of charge. The assigned channel threshold 6.3 also behaves dynamically, with a rise to a higher level over time also being shown. This is due to altered vehicle surroundings data, with the vehicle passing a hazard area, for example motorway roadworks, and therefore the driver needs to be more alert. The notification management system accordingly adjusts a channel threshold to a higher value, to reduce the flow of information to the driver.

At time t4, the priority number 5.3 then exceeds the assigned channel threshold 6.3, so that the notification management system forwards the notification 4.1 to the notification channel 1.3, with a database in turn being queried to convert the notification 4.1 into a primary voice message. Distributing the primary voice message at time t4 causes a change to the state data of the man-machine interface, so that the notification 4.1 is deleted from the waiting loops for the notification channels 4.2 and 4.3. Therefore, switching the notification channel 1.2 to the normal operating mode because of the output of the primary voice message via the notification channel 1.3 has no perceptible effect, since the waiting loop thereof was emptied beforehand.

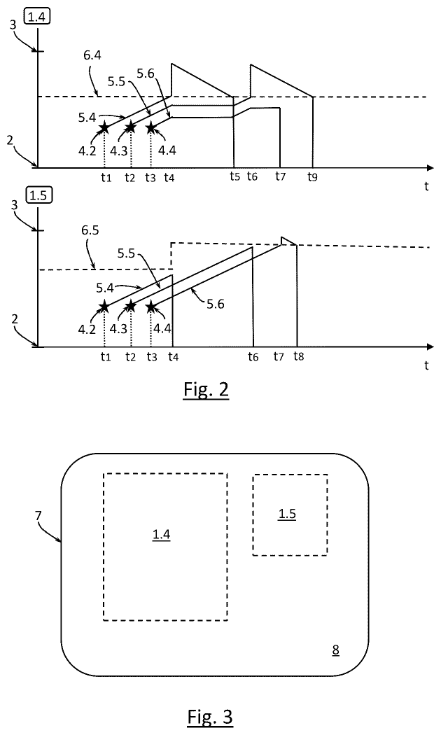

For the exemplary embodiment shown in FIG. 2, there are three notifications 4.2, 4.3, 4.4 in the form of system messages that compete for two possible notification channels 1.4, 1.5, and the schematically simplified illustration in FIG. 3 illustrates that the two notification channels 1.4, 1.5 are formed by two differently-sized areas on a display 7 that is assigned to a man-machine interface 8.

It is apparent from FIG. 2 that the notification channel 1.4 takes preference over the notification channel 1.5 because the channel threshold 6.4 is set lower. Nevertheless, none of the notifications 4.2, 4.3, 4.4, which are included in the waiting loops for the notification channels 1.4, 1.5 staggered at different times t1, t2 and t3, has a priority number 5.4, 5.5, 5.6 that is sufficient for the forwarding. Due to the rising dynamics of the priority numbers 5.4, 5.5, 5.6, these move closer to the two channel thresholds 6.4, 6.5 over time, with the notification 4.2 being the first to exceed the threshold 6.4 of the notification channel 1.4 and be forwarded thereto. This is associated with a change in the state data of the man-machine interface 8, which leads to a further dynamic adjustment of the priority numbers 5.4, 5.5, 5.6. In the process, the priority number 5.4, which is assigned to the forwarded notification 4.2, is increased by a constant value, with a degression subsequently occurring. This measure has the effect that the notification 4.2 remains active for a predetermined time on the notification channel 1.4 and only expires when its priority number 5.4 falls back below the channel threshold 6.4. During this time, the change in the state data the man-machine interface 8 prevents the priority numbers 5.5, 5.6 of the notifications 4.3, 4.4 from rising further.

The activation of the first notification channel 1.4 has effects on the second notification channel 1.5. It can be seen that with the presentation of the notification 4.2 on the first notification channel 1.4, the channel threshold 6.5 of the second notification channel 1.5 rises at t4. Opening a further window on the display 7 is therefore associated with increased “costs”, and the rise in the channel threshold 6.5 relaxes over the further course of time. However, this drop in the channel threshold 6.5 is insufficient to stop the reactivation of the preferred notification channel 1.4 at t6, in which case the priority number 5.5 exceeds the channel threshold 6.4 and the next notification 4.3 is forwarded for the display. Only for the time span from t7 to t8 does an additional activation of the notification channel 1.5 occur due to the notification 4.4.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A notification management method for a vehicle-based man-machine interface comprising at least one notification channel, the notification management method comprising:
forwarding or withholding forwarding a notification, by a notification management system based on a priority linked to the notification, to the at least one notification channel, wherein the notification is directed to at least one vehicle occupant or a vehicle functional module,
wherein the priority linked to the notification is set by a priority number,
wherein the notification is selected and forwarded to the notification channel when the priority number linked to the notification exceeds a channel threshold assigned to the at least one notification channel and when the notification has a highest priority number for the at least one notification channel, and
wherein the channel threshold varies over time and is set, in a normal operating mode, between a minimum threshold and a maximum threshold by the notification management system in specified time intervals based on driving data, vehicle surroundings data, vehicle data, state data of the man-machine interface, at least one previous notification transmission, or vehicle occupant observation data.

12. The notification management method of claim 11, wherein the priority number of the notification varies over time at least until transmission to the at least one notification channel and the priority number of the notification is set, in the normal operating mode, to a value between a priority minimum above the minimum threshold and a priority maximum below the maximum threshold by the notification management system in specified time intervals based on the driving data, vehicle surroundings data, vehicle data, at least one previous notification transmission by the man-machine interface, vehicle occupant observation data, time spent in a waiting loop of the at least one notification channel, or a duration of an activation state of a notification in the at least one notification channel.

13. The notification management method of claim 11, wherein after forwarding the notification to the at least one notification channel, the notification management system raises the assigned channel threshold in a next time interval.

14. The notification management method of claim 13, wherein after forwarding the notification to the at least one notification channel, the channel threshold assigned to the at least one notification channel is set to the maximum threshold for a predetermined time duration.

15. The notification management method of claim 13, wherein after raising the assigned channel threshold for a specified time period after forwarding the notification, the assigned channel threshold is reduced.

16. The notification management method of claim 11, wherein the notification forwarded to the at least one notification channel remains active in the at least one notification channel until the priority number of the notification is below the assigned channel threshold value.

17. The notification management method of claim 11, wherein the at least one notification channel comprises a plurality of notification channels, and wherein the notification management system defines a separate channel threshold that can vary over time for each individual notification channel of the plurality of notification channels and a separate priority number is assigned in each case to a notification for at least two of the plurality of notification channels.

18. The notification management method of claim 17, wherein a change to the channel threshold of a first notification channel causes the channel threshold of at least one second notification channel of the plurality of notification channels to change.

19. The notification management method of claim 17, wherein, based on the driving data, vehicle surroundings data, vehicle data, vehicle occupant observation data, or vehicle-external notification, a switch is made from the normal operating mode to a rule-based mode for at least one notification channel of the plurality of notification channels, and wherein the notification management system sets the channel threshold to the minimum threshold or the maximum threshold for at least one notification channel selected for the rule-based mode.

20. A vehicle comprising:
a man-machine interface comprising at least one notification channel; and
notification management system coupled to the man-machine interface,
wherein the notification management system is configured to
forward or withhold forwarding a notification, based on a priority linked to the notification, to the at least one notification channel, wherein the notification is directed to at least one vehicle occupant or a vehicle functional module,
wherein the priority linked to the notification is set by a priority number,
wherein the notification is selected and forwarded to the notification channel when the priority number linked to the notification exceeds a channel threshold assigned to the at least one notification channel and when the notification has a highest priority number for the at least one notification channel, and
wherein the channel threshold varies over time and is set, in a normal operating mode, between a minimum threshold and a maximum threshold by the notification management system in specified time intervals based on driving data, vehicle surroundings data, vehicle data, state data of the man-machine interface, at least one previous notification transmission, or vehicle occupant observation data.
